(19) United States
(12) Patent Application Publication
(10) Pub. No.: US 2006/0107583 A1
(43) Pub. Date: May 25, 2006

(54) Insect-catching lamp

(76) Inventor: Pao-Huang Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/994,487

(22) Filed: Nov. 23, 2004

(51) Int. Cl. A01M 1/04; A01M 1/14

(52) U.S. Cl. 43/113; 43/114

(57) ABSTRACT

An insect-catching lamp includes a casing having its front side bored with a through opening. The casing is installed with an insect-luring lamp of LED in the interior and provided with a deep-colored adhesive paper at one inner side. When the LED emits bright light outward, mosquitoes will be attracted to fly around the insect-luring lamp and be stuck by the adhesive paper. The insect-catching lamp of this invention is provided with neither electrode bars nor high-voltage electronic elements so it is quite safe in use and able to prevent people from touching the adhesive paper. In addition, the insect-luring lamp employs the low-power LED as an electric source, able to lower consumption of electricity, prolong service life and reduce cost in use.

### BACKGROUND OF THE INVENTION

1. Field of the Invention

This invention relates to an insect-catching lamp. Particularly to one having a casing provided with an adhesive paper at one inner side and an insect-luring lamp of LED (light emitting diode) in the interior. When the LED emits bright light outward, insects such as mosquitoes will be attracted by the bright light to fly around the insect-luring lamp and be stuck by the adhesive paper, safe in use, and able to prevent people from touching the adhesive paper and avoid the appearance of the insect-catching lamp being soiled. In addition, the low-power LED is employed as an electric source, able to lower consumption of electricity and prolong service life.

2. Description of the Prior Art

Insects, especially mosquitoes, almost fly in any living surroundings. They not only make noises to disturb people in sleep, but also sting people to cause red swelling and itching of skin, and if more seriously, they are transmitting media of infectious diseases, such as dengue fever that has happened frequently in recent years.

Nowadays, various kinds of insect-repellent appliances are sold on the market for exterminating mosquitoes, such as insecticide, mosquito-repelling incense, mosquito swatter, mosquito-catching lamp and the like. However, the insecticide and the insect-repelling incense are more or less harmful to human health and possible to let mosquitoes produce resistance to the function of drug if used for a long-term, while the mosquito swatter has to be held and waved around for getting rid of mosquitoes, inconvenient in use and not effective.

A conventional mosquito-catching lamp 4, as shown in FIG. 6, includes a bottom base 41 having a circular protective net 42 vertically provided on the outer circumferential surface. The circular protective net 42 has its topside assembled thereon with an upper base 43 covered with an upper cover 44 and disposed thereon with a circuit board 45 able to generate DC high voltage.

A plurality of anode and cathode bars 46, 47 are densely and circularly arranged in an intersecting condition between the bottom base 41 and the upper base 43, and a glass tube 48 is provided to output DC high voltage produced by the circuit board 45 to the anode and cathode bars 46, 47. Thus, when mosquitoes are attracted by the light of the glass tube 48 to fly into the insect-catching lamp 4 and touch the anode and the cathode bars 46, 47, they will be killed by the DC high voltage produced by the anode and the cathode bars 46, 47.

However, this conventional insect-catching lamp has the following defects.

1. DC high voltage is supplied for killing mosquitoes, expending too mush electric energy and increasing cost in use.

2. People are likely to touch the anode and the cathode bars by accident and receive electric shock, dangerous in use and likely to make noises.

3. Mosquitoes killed by high voltage may stick to the anode and the cathode bars or drop down to the place around the insect-catching lamp, troublesome in cleaning and likely to multiply bacteria or entice ants to soil the nearby environments.

To improve the defects mentioned above, a sticky insect-catching appliance 5 has been researched and developed, as shown in FIGS. 7 and 8. Such a sticky mosquito-catching appliance 5 is provided with a base body 51 for connecting an external AC electric source or for installing a DC electric source. A luminous body 52 is assembled on the base body 51, having its outer circumference covered up with a transparent cover 53 that has its outer edge directly applied with or additionally provided with a transparent glue layer 54. Thus, light produced by the luminous body 52 will emit out through the transparent cover 53 and the transparent glue layer 54 to attract mosquitoes to fly toward the light and be stuck on the transparent glue layer 54. However, this sticky insect-catching appliance 5 has some drawbacks in structure as described below.

1. The sticky surface of the transparent glue layer faces the outer circumferential surface of the insect-catching appliance; therefore, people, especially curious and naughty children, are likely to touch the sticky surface accidentally and be stuck by the glue.

2. The sticky surface for catching mosquitoes faces the outer surface of the insect-catching appliance; therefore, after used for a period of time, the transparent glue layer will be covered with dead mosquitoes, dust or other dirt, spoiling the external beauty of the insect-catching appliance.

In addition, the above-mentioned insect-catching lamp or insect-catching appliance is provided with conventional high-power glass tubes for emitting light to lure mosquitoes, but such high-power glass tubes consume comparatively much electric energy and have a comparatively short service life, necessary to be replaced with new ones frequently to increase cost in use.

### SUMMARY OF THE INVENTION

The objective of the invention is to offer a insect-catching lamp provided with a casing having its front side bored with a through opening. The casing is disposed with a mosquito-luring lamp of LED (light emitting diode) in the interior for attracting mosquitoes, and has one inner side provided with an adhesive paper. When the LED emits bright light outward, mosquitoes will be attracted to fly toward the light and be stuck by the adhesive paper. The insect-catching lamp of this invention is safe in use, and able to prevent people from touching the adhesive paper and avoid soiling or spoiling of the external appearance of the insect-catching lamp. Additionally, the low-power LED consumes less electric energy and has a comparatively long service life, reducing cost in use and having great practicability.

### BRIEF DESCRIPTION OF DRAWINGS

This invention will be better understood by referring to the accompanying drawings, wherein:

FIG. 1 is an exploded perspective view of a first preferred embodiment of an insect-catch lamp in the present invention:

FIG. 2 is a side cross-sectional view of the first preferred embodiment of the insect-catching lamp in the present invention:

FIG. 3 is a side cross-sectional view of the first preferred embodiment of the insect-catching lamp in a using condition in the present invention:

FIG. 4 is an exploded perspective view of a second preferred embodiment of an insect-catching lamp in the present invention:

FIG. 5 is an exploded perspective view of a third preferred embodiment of an insect-catching lamp in the present invention:

FIG. 6 is a cross-sectional view of a first conventional insect-catching lamp:

FIG. 7 is a front view of a second conventional insect-catching lamp: and

FIG. 8 is a cross-sectional view of the second conventional insect-catching lamp.

### DETAILED DESCRIPTION OF THE PREFERRED EMBODIMENT

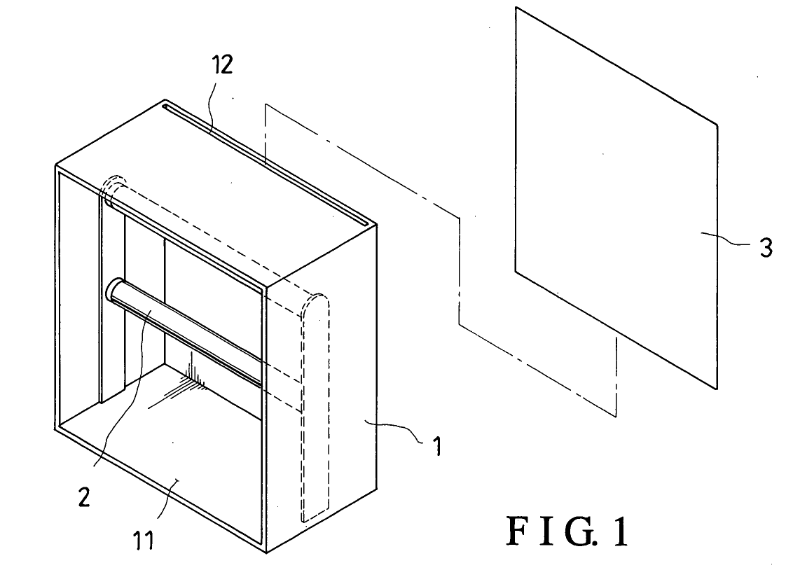

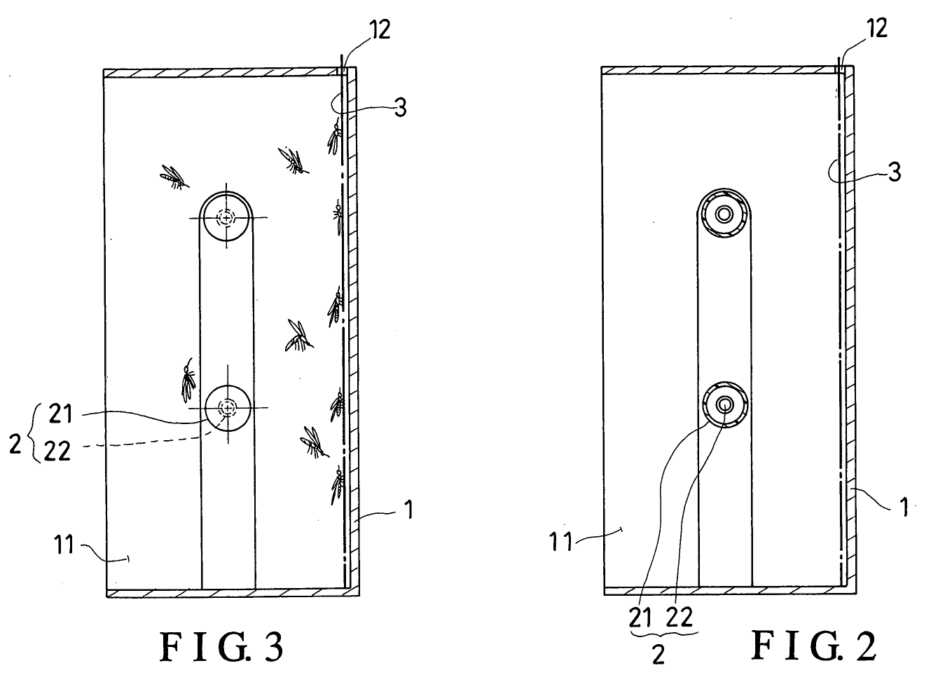

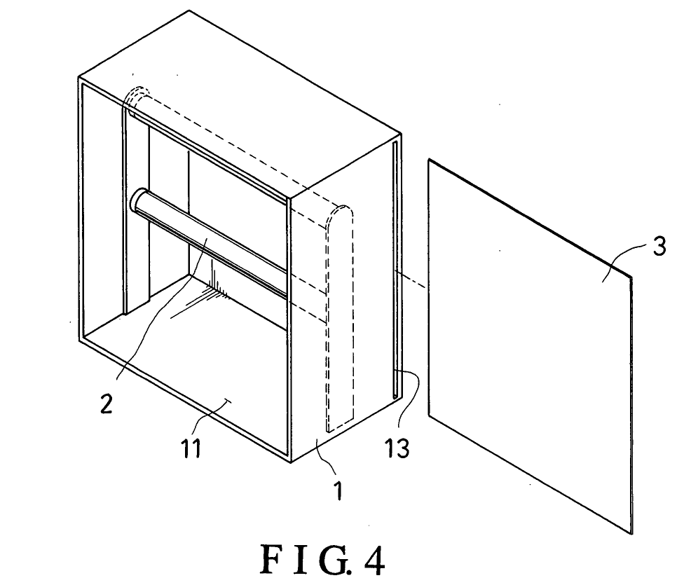

A first preferred embodiment of a mosquito-catching lamp in the present invention, as shown in FIGS. 1 and 2, includes a casing 1 having its front side bored with a through opening 11. The casing 1 can be connected with an external AC electric source or installed with a DC electric source. In addition, the casing 1 is provided in the interior with an insect-luring lamp 2 that is composed of a light-guiding tube 21 and an LED 22 (light emitting diode) installed inside the light-guiding tube 21. The casing 1 further has its upper rear side bored with transverse elongate slot 12 facing the interior for a deep-colored (like black) adhesive paper 3 to be inserted therethrough and positioned in the interior of the casing 1.

Thus, when the LED of the insect-luring lamp 2 makes electric connection and emits bright light toward the opening 11, mosquitoes will be attracted by the light to fly into the casing 1 and approach the insect-luring lamp 2, and when they fly around the insect-luring lamp 2 in the casing 1, they will finally touch the adhesive paper 3 positioned in the casing 1 and be stuck thereon, able to catch mosquitoes effectively.

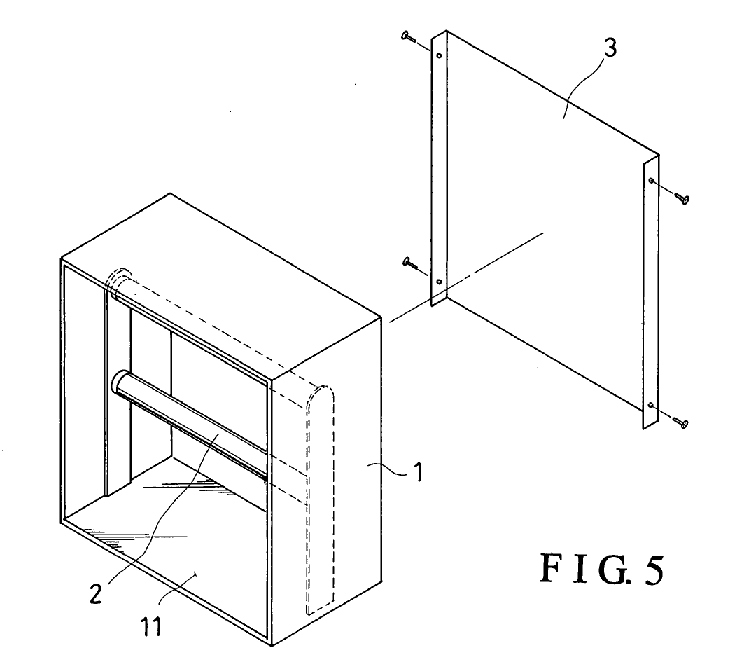

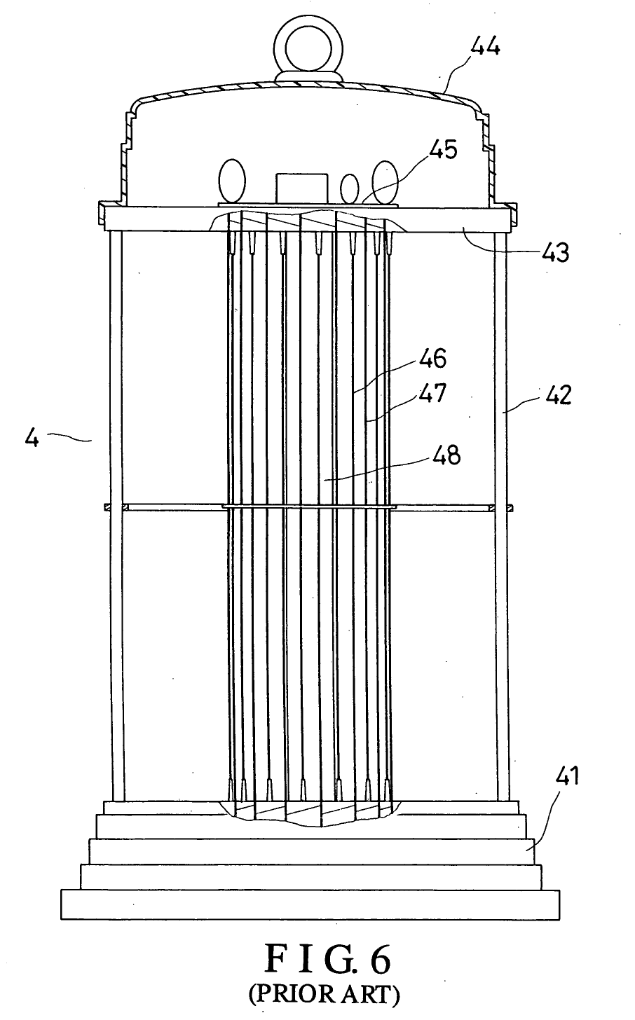

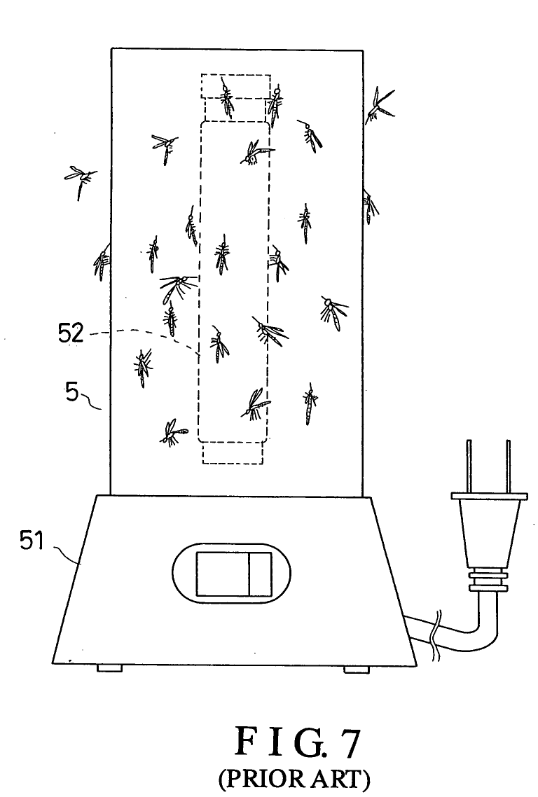

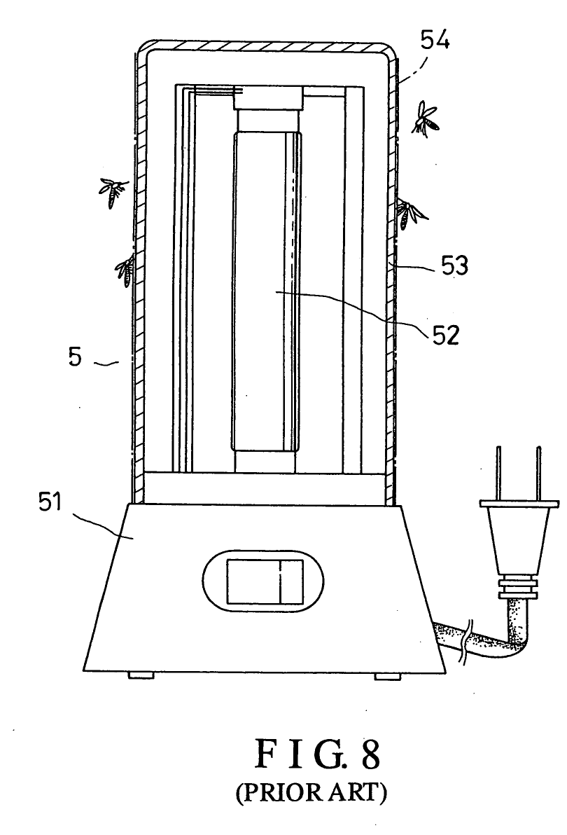

A second preferred embodiment of an insect-catching lamp in the present invention, as shown in FIG. 4, has almost the same structure as that of the first preferred embodiment, except that a vertical elongate slot 13 is bored in the lateral rear side of the casing 1 for the adhesive paper 3 to be transversely inserted therethrough and positioned inside the casing 1.

A third preferred embodiment of an insect-catching lamp in the present invention, as shown in FIG. 5, has almost the same structure as that of the first preferred embodiment, except that the rear side of the casing 1 is hollowed out and the adhesive paper 3 is directly fixed on the rear hollowed side of the casing 1.

As can be understood from the above description, the insect-catching lamp of this invention has the following advantages, compared with the conventional ones.

1. It catches mosquitoes in a way of sticking so a user is needless to pay extra expense for the electric energy consumed by DC high voltage.

2. It catches mosquitoes in a way of sticking so accident of electric shock and injury will never happen, quite safe in use.

3. It is not necessary to provide electrode bars and high-voltage electronic elements, able to lower producing cost.

4. Mosquitoes are caught and stuck on the adhesive paper inserted in the casing, easy and convenient to be cleaned out and impossible to multiply bacteria and cause pollution to the environment.

5. The adhesive paper is inserted in the interior or directly fixed on the hollowed rear side of the casing, and the insect-luring lamp is installed inside the casing for luring mosquitoes to fly around and be stuck by the adhesive paper, able to prevent people from touching the adhesive paper by accident.

6. The adhesive paper inserted in the interior of the casing is of a deep color so the adhesive paper and the mosquitoes stuck thereon cannot be seen clearly, impossible to spoil the external beauty of the mosquito-catching lamp.

7. The insect-luring lamp employs low-power LED as a luminous source for attracting mosquitoes to fly around the insect-luring lamp and be stuck by the adhesive paper, having a long service life and able to lower consumption of electricity.

While the preferred embodiments of the invention have been described above, it will be recognized and understood that various modifications may be made therein and the appended claims are intended to cover all such modifications that may fall within the spirit and scope of the invention.

What is claimed is:

1. An insect-catching lamp comprising a casing, said casing having its front side bored with a through opening, said casing able to be connected with an external electric source, said casing installed inside with an insect-luring lamp of LED (light emitting diode), said casing having its one inner side provided with a deep-colored adhesive paper: and
Said LED of said insect-luring lamp emitting bright light outward, said bright light attracting mosquitoes to fly around said mosquito-luring lamp and be stuck by said adhesive paper.

2. The insect-catching lamp as claimed in claim 1, wherein said casing has its upper rear side bored with a transverse elongate slot for said adhesive paper to be inserted therein.

3. The insect-catching lamp as claimed in claim 1, wherein said casing has its lateral rear side bored with a vertical elongate slot for said adhesive paper to be inserted therein.

4. The insect-catching lamp as claimed in claim 1, wherein said casing has its rear side hollowed out and said adhesive paper is fixed on said hollowed rear side of said casing.

5. The insect-catching lamp as claimed in claim 1, wherein said mosquito-luring lamp comprises a light-guiding tube having said LED installed in the interior.
